(19) United States
(12) Patent Application Publication
(10) Pub. No.: US 2019/0089675 A1
(43) Pub. Date: Mar. 21, 2019

(54) NETWORK ADDRESS TRANSLATION DEVICE, SETTING REQUESTING DEVICE, COMMUNICATION SYSTEM, COMMUNICATION METHOD AND STORAGE MEDIUM STORING PROGRAM

(71) Applicant: NEC Corporation, Minato-ku, Tokyo (JP)

(72) Inventor: Fumihiro TANIGUCHI, Tokyo (JP)

(73) Assignee: NEC Corporation, Minato-ku, Tokyo (JP)

(21) Appl. No.: 16/079,601

(22) PCT Filed: Mar. 14, 2017
(86) PCT No.: PCT/JP2017/010068

§ 371 Date: Aug. 24, 2018

(30) Foreign Application Priority Data
Mar. 16, 2016 (JP) JP2016-052563

(51) Int. Cl. H04L 29/12

(52) U.S. Cl. CPC H04L 61/2575; H04L 61/2521; H04L 61/2517

(57) ABSTRACT

[Problem] To allow a packet transmitted from an external node to be delivered to a subscriber device, when a network address translation device is restarted.

[Solution] A network address translation device according to an exemplary aspect of the invention includes: a mapping setting unit that sets a static port mapping in response to a request from a setting requesting device that requests setting of the static port mapping; and a flow transmitting unit that subjects a packet flow from a subscriber device to address translation, based on the static port mapping that has been set by the mapping setting unit, and transmits the packet flow, wherein when the network address translation device is restarted, the flow transmitting unit discards the packet flow until receiving, from the setting requesting device, a notification that indicates completion of re-setting of the static port mapping for the network address translation device.

### TECHNICAL FIELD

The present invention relates to a network address translation (NAT) device, a setting requesting device, a communication system, a communication method, and a program, and more particularly, to a network address translation device that can perform setting of a port mapping by using a port control protocol (PCP), a setting requesting device that requests setting of a port mapping by using the PCP, a communication system that includes these devices, a communication method, and a program.

### BACKGROUND ART

In order to compensate for depletion of Internet protocol version 4 (IPv4) addresses, a network address translation (NAT) that uses private IP addresses in a local network and, when connected to Internet, translates the private IP addresses into public IP addresses (or global IP addresses) has been used. With network address port translation (NAPT) being also introduced that remaps IP addresses as well as port numbers of a transmission control protocol (TCP) or a user datagram protocol (UDP), communication among a plurality of hosts is possible using a single public IP address.

Moreover, because of IPv4 address exhaustion that has become serious in recent years, carrier grade network address translation (CGNAT) (also referred to as CGN) in which general functions of the NAT are expanded also has been used in order to implement the NAT (in large) for each communications service provider.

FIG. 13 is a sequence diagram that exemplifies operations of a communication system according to a relevant art. In FIG. 13, a CGN device is one that implements the CGNAT (CGN). A port control protocol (PCP) setting control device sets, to the CGN device, port mapping information that is instructed from a subscriber device (e.g., personal computer (PC)). When the PCP setting control device sets the port mapping information to the CGN device, the PCP setting control device uses a standard compliant protocol, Port Control Protocol (PCP) that is defined in request for comments (RFC) 6887 (NPL 1).

After confirming that a set of a public IP address and a public port number included in the port mapping information is not used for another port mapping that has been set in the CGN device, the CGN device performs setting of a port mapping for the CGN device itself, and sends back a PCP MAP response message that notifies of success. On the other hand, when the set of the public IP address and the public port number is already used for a port mapping that has been set on another apparatus, the CGN device sends back a PCP MAP response message that notifies the PCP setting control device of failure of setting. Further, the PCP setting control device stores and retains the port mapping that has been set.

In addition to performing NAT translation of a data flow from the subscriber device, the CGN device performs NAT translation of a data flow toward the set of the public IP address and the public port number of the port mapping that has been set by PCP MAP as communication for the set of the private IP address and the private port number that has been set. In cases where a data flow that does not match the port mapping has been received, when the packet thereof is one that is received from the subscriber device, the CGN device assigns a set of an unused public IP address and public port thereto, dynamically generates a port mapping, and forwards the packet after NAT translation. On the other hand, when the packet is one that has been received from an external node, the CGN device discards the packet.

Note that, as a relevant art, common requests for CGNAT are defined in RFC6888 (NPL 2). In RFC6333 (NPL 3), Dual-Stack Lite technology that enables broadband service providers to share Internet protocol version 4 (IPv4) addresses among customers is described. Further, in RFC4787 (NPL 4), Endpoint-Independent Mapping behavior and Endpoint-Independent Filtering behavior are defined.

### CITATION LIST

### Patent Literature

[PTL 1] WO2012/133060A1

### Non Patent Literature

[NPL 1] Internet Engineering Task Force (IETF), Request for Comments: 6887, “Port Control Protocol (PCP),” April 2013, <URL: https://tools.ietf.org/html/rfc6887>.
[NPL 2] Internet Engineering Task Force (IETF), Request for Comments: 6888, “Common Requirements for Carrier-Grade NATs (CGNs),” April 2013, <URL: https://tools.ietf.org/html/rfc6888>.
[NPL 3] Internet Engineering Task Force (IETF), Request for Comments: 6333, “Dual-Stack Lite Broadband Deployments Following IPv4 Exhaustion,” August 2011, <URL: https://tools.ietf.org/html/rfc6333>.
[NPL 4] Internet Engineering Task Force (IETF), Request for Comments: 4787, “Network Address Translation (NAT) Behavioral Requirements for Unicast UDP,” January 2007, <URL: https://tools.ietf.org/html/rfc4787>.

### SUMMARY OF INVENTION

### Technical Problem

Assuming that the entire disclosed contents of NPLs 1 to 4 above are incorporated and described herein by reference. The following analysis has been made by the present inventor.

In a standard compliant port control protocol (PCP), when the carrier grade network address translation (CGN) device are restarted, the CGN device starts without port mapping information. After restarted, the CGN device performs the following three processes of (1) to (3) in parallel. Processing thereof will be described using FIG. 13.

Processing (1): the CGN device transmits a PCP ANNOUNCE response message to the PCP setting control device (Step 1 in FIG. 13).

Processing (2): when a packet flow has been delivered, the CGN device performs a dynamic port mapping and immediately implements NAT forwarding (Step 2 through Step 6 in FIG. 13).

Processing (3): when a PCP MAP request message has been delivered from the PCP setting control device, the CGN device sets a static port mapping (Step 7 through Step 10 in FIG. 13).

On the other hand, the PCP setting control device re-sets a static port mapping to the CGN device by transmitting a PCP MAP request (transmission of Step 7 in FIG. 13), which is triggered by the PCP ANNOUNCE response message of the processing (1) (Step 1 in FIG. 13).

The problem in this case is that a set of a public IP address and a public port number that is assigned to the packet flow through the dynamic port mapping by the CGN device in the processing (2) could compete with a set of a public IP address and a public port number that is designated through the static port mapping in the processing (3). This competition is detected at a timing of Step 8 in FIG. 13.

When a timing of the processing (3) is earlier than a timing of the processing (2), forwarding of the packet can be continued by using any other appropriate port number in the processing (2).

On the other side, when the timing of the processing (2) is earlier than a timing of the processing (3), setting of the static port mapping fails. In cases where the static port mapping fails, the problem is that even if a packet is transmitted from the external node toward the public IP address and the port number that have been set prior to the restarting of the CGN device, the packet cannot be delivered to the subscriber device (for example, PC).

Namely, according to the relevant art, the problem is that when the CGN device that is a network address translation device is restarted, a packet transmitted from the external node to the subscriber device becomes incapable to be delivered if re-setting of the static port mapping fails. In addition, this also raises the problem that the original static port mapping cannot be restored as long as the port mapping that competes with the static port mapping that has failed to be re-set is released.

Hence, a problem to be solved is to allow the packet transmitted from the external node to be delivered to the subscriber device, when the network address translation device is restarted. An object of the present invention is to provide a network address translation device, a setting requesting device, a communication system, a communication method and a program that contributes to solve such a problem.

### Solution to Problem

A network address translation device according to a first aspect of the present invention includes: a mapping setting unit that sets a static port mapping in response to a request from a setting requesting device that requests setting of the static port mapping; and a flow transmitting unit that subjects a packet flow from a subscriber device to address translation, based on the static port mapping that has been set by the mapping setting unit, and transmits the packet flow, wherein when the network address translation device is restarted, the flow transmitting unit discards the packet flow until receiving, from the setting requesting device, a notification that indicates completion of re-setting of the static port mapping for the network address translation device.

A setting requesting device according to a second aspect of the present invention includes: a requesting unit that requests setting of a static port mapping for a network address translation device that subjects a packet flow from a subscriber device to address translation, based on the static port mapping that has been set, and transmits the packet flow; and a notifying unit that, when the network address translation device is restarted, notifies the network address translation device of completion of re-setting of the static port mapping for the network address translation device upon the completion of the re-setting.

A communication system according to a third aspect of the present invention includes: a setting requesting device that requests setting of a static port mapping; and a network address translation device that sets the static port mapping in response to a request from the setting requesting device, subjects a packet flow from a subscriber device to address translation, based on the static port mapping that has been set, and transmits the packet flow, wherein when the network address translation device is restarted, the network address translation device discards the packet flow until receiving, from the setting requesting device, a notification that indicates completion of re-setting of the static port mapping for the network address translation device.

A communication method according to a fourth aspect of the present invention includes the steps of: restarting a network address translation device that sets a static port mapping in response to a request from a setting requesting device that requests setting of the static port mapping, subjects a packet flow from a subscriber device to address translation, based on the static port mapping that has been set, and transmits the packet flow; receiving, by the network address translation device, a notification that indicates completion of re-setting of the static port mapping for the network address translation device from the setting requesting device, after the restarting; and discarding, by the network address translation device, the packet flow until receiving the notification.

A program according to a fifth aspect of the present invention causes a computer provided in a network address translation device that sets a static port mapping in response to a request from a setting requesting device that requests setting of the static port mapping, subjects a packet flow from a subscriber device to address translation, based on the static port mapping that has been set, and transmits the packet flow to execute: a process of restarting the network address translation device; a process of, after the restarting, receiving a notification that indicates completion of re-setting of the static port mapping for the network address translation device from the setting requesting device; and a process of discarding the packet flow until receiving the notification. Note that the program may also be provided as a program product that is recorded in a non-transitory computer-readable storage medium.

### Advantageous Effects of Invention

According to a network address translation device, a setting requesting device, a communication system, a communication method and a program according to the present invention, the packet transmitted from the external node can be delivered to the subscriber device, when the network address transport device is restarted.

### BRIEF DESCRIPTION OF DRAWINGS

FIG. 1 shows a block diagram that exemplifies a configuration of a network address translation device according to one example embodiment.

FIG. 2 shows a block diagram that exemplifies a configuration of a setting requesting device according to one example embodiment.

FIG. 3 shows a diagram that exemplifies a system configuration of a communication system according to a first example embodiment.

FIG. 4 shows a block diagram that exemplifies configurations of a PCP setting control device and a CGN device in the first example embodiment.

FIG. 5 shows a diagram for illustrating data flows in the first example embodiment and a method for determining identicalness thereof.

FIG. 6 shows a sequence diagram that exemplifies operations of processing for an outbound packet in the first example embodiment.

FIG. 7 shows a flow diagram that exemplifies detailed operations of processing for the outbound packet by the CGN device in the first example embodiment.

FIG. 8 shows a sequence diagram that exemplifies operations of a static port mapping in the first example embodiment.

FIG. 9 shows a sequence diagram that exemplifies operations of processing for an inbound packet in the first example embodiment.

FIG. 10 shows a flow diagram that exemplifies detailed operations of processing for the inbound packet by the CGN device in the first example embodiment.

FIG. 11 shows a sequence diagram that exemplifies operations for restarting of a CGN device in a communication system according to one example embodiment.

FIG. 12 shows a diagram that exemplifies a system configuration of a communication system according to a second example embodiment.

FIG. 13 shows a sequence diagram that exemplifies operations for restarting of a CGN device in a communication system according to a relevant art.

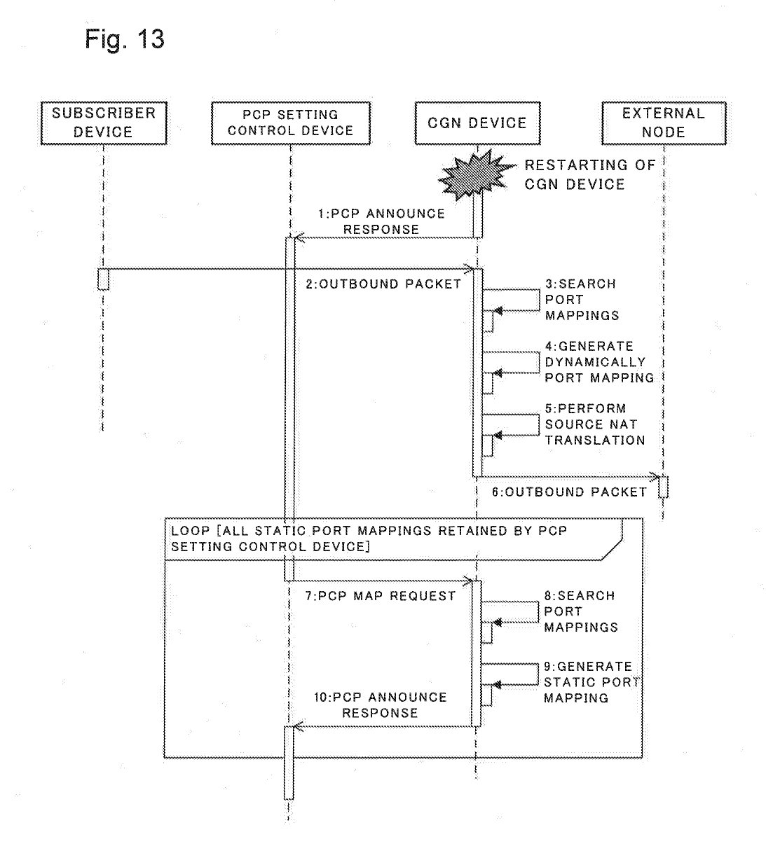

### EXAMPLE EMBODIMENT

First, an outline of one example embodiment will be summarized. Note that reference signs of the drawings applied in this summarization are exemplifications for mainly helping understanding of the invention and are not intended to limit the present invention to illustrated aspects.

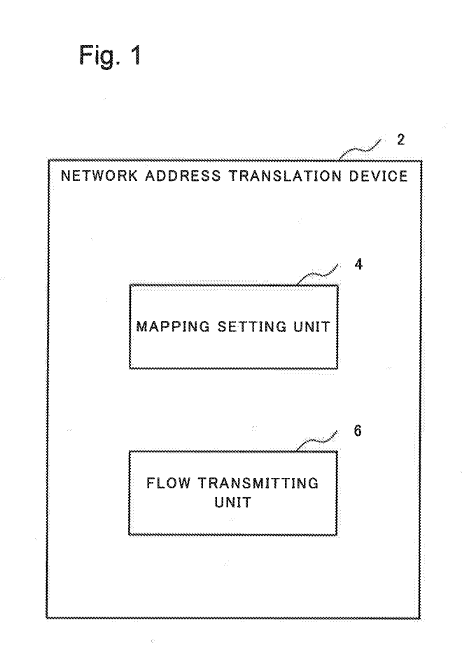

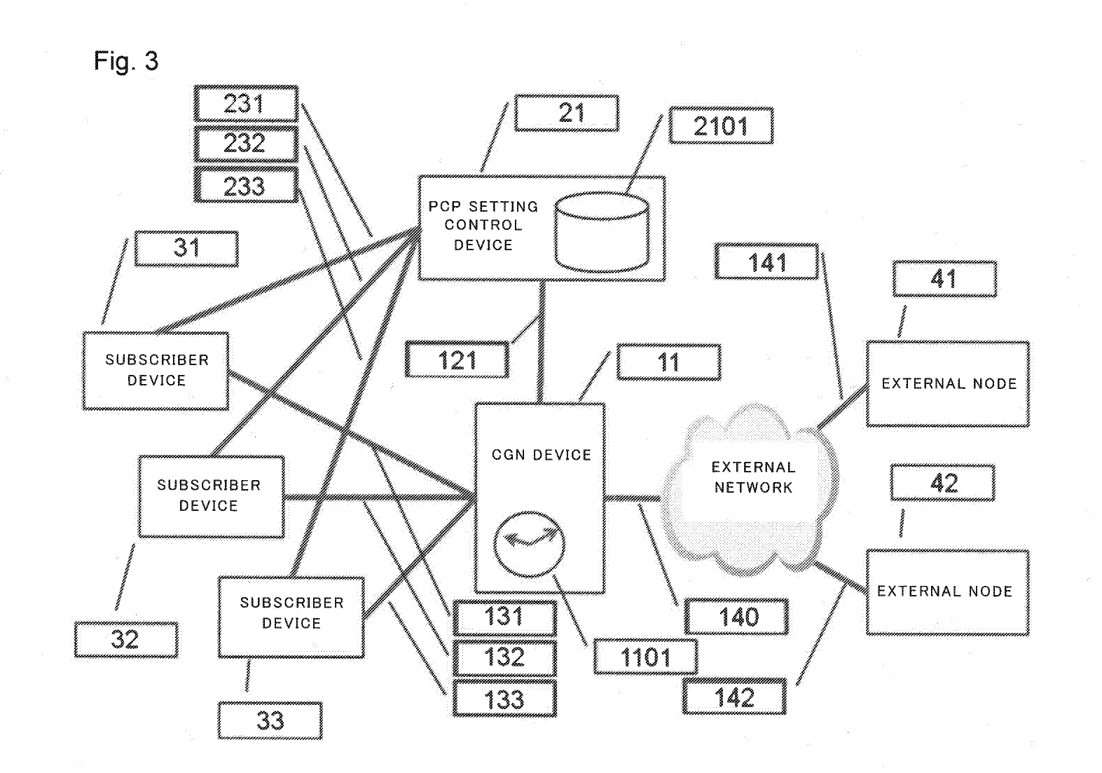

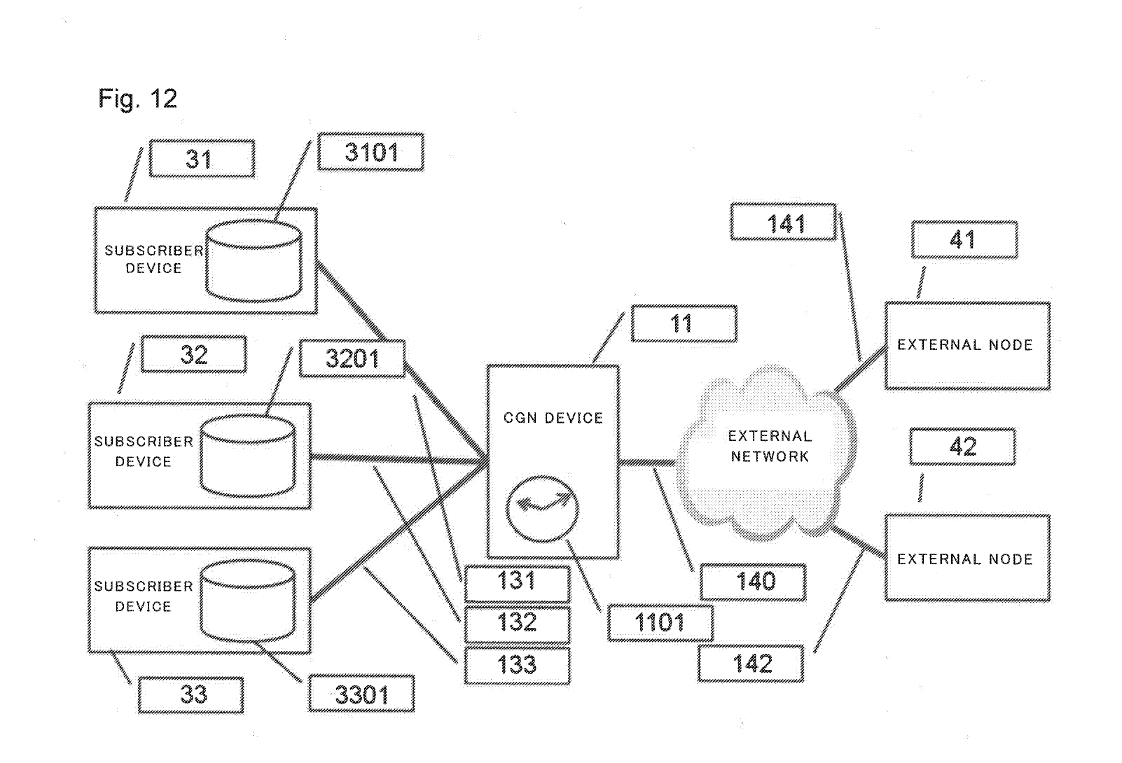

FIG. 1 is a block diagram that exemplifies a configuration of a network address translation device 2 according to one example embodiment. With reference to FIG. 1, the network address translation device 2 (e.g., CGN device 11 in FIG. 3, FIG. 12) includes a mapping setting unit 4 that sets a static port mapping in response to a request from a setting requesting device (e.g., PCP setting control device 21 in FIG. 3, subscriber devices 31 to 33 in FIG. 12) that requests setting of the static port mapping; and a flow transmitting unit 6 that subjects a packet flow from the subscriber device (e.g., subscriber devices 31 to 33 in FIG. 3, FIG. 12) to address translation (e.g., NAT, NAPT, CGNAT), based on the static port mapping that has been set by the mapping setting unit 4, and transmits the packet flow. When the network address translation device 2 is restarted, the flow transmitting unit 6 discards the packet flow from the subscriber device until receiving, from the setting requesting device, a notification that indicates completion of re-setting of the static port mapping for the network address translation device 2.

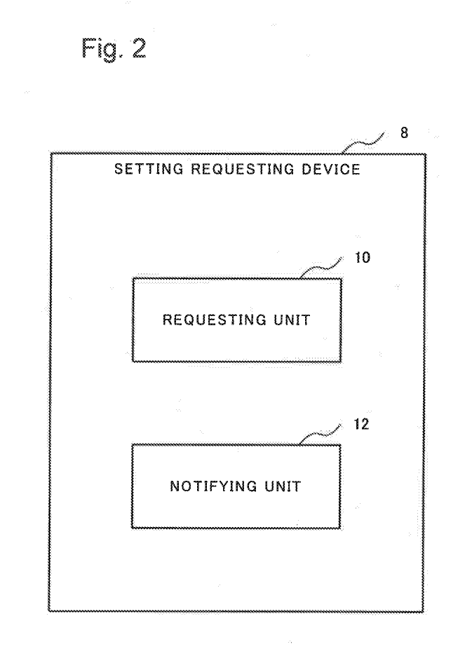

FIG. 2 is a block diagram that exemplifies a configuration of a setting requesting device 8 according to one example embodiment. With reference to FIG. 2, a setting requesting device 8 (e.g., PCP setting control device 21 in FIG. 3, subscriber devices 31 to 33 in FIG. 12) includes a requesting unit 10 that requests setting of a static port mapping for a network address translation device (e.g., CGN device 11 in FIG. 3, FIG. 12) that subjects a packet flow from a subscriber device (e.g., subscriber devices 31 to 33 in FIG. 3, FIG. 12) to address translation (e.g., NAT, NAPT, CGNAT), based on the static port mapping that has been set, and transmits the packet flow; and a notifying unit 12 that notifies the network address translation device of completion of re-setting of the static port mapping for the network address translation device upon the completion of the re-setting, when the network address translation device is restarted.

Such a network address translation device or setting requesting device allows the packet transmitted from an external node to ensure to be delivered to the subscriber device, even when the network address translation device is restarted. The reason is that when the network address translation device is restarted, the packet flows from the subscriber device are discarded until receiving, from the setting requesting device, the notification that indicates the completion of the re-setting of the static port mapping for the network address translation device, and therefore the network address translation device can complete the static port mapping prior to performing of a dynamic port mapping for the packet flows from the subscriber device.

A case where the network address translation device 2 of the one example embodiment above corresponds to the CGN device and the setting requesting device 8 corresponds to the PCP setting control device will be further described in detail. In this case, when the CGN device that can perform setting of a port mapping by using PCP is restarted, the CGN device does not implement forwarding of packet flows from the subscriber device (PC or the like) immediately after the restarting, but preferably starts to forward the packet flows after awaiting either receipt of a PCP message that notifies of completion of setting of a PCP MAP request, or a lapse of a certain time from the resetting. In addition, it is preferred that the PCP setting control device notify the CGN device of the completion of the setting of the PCP MAP request.

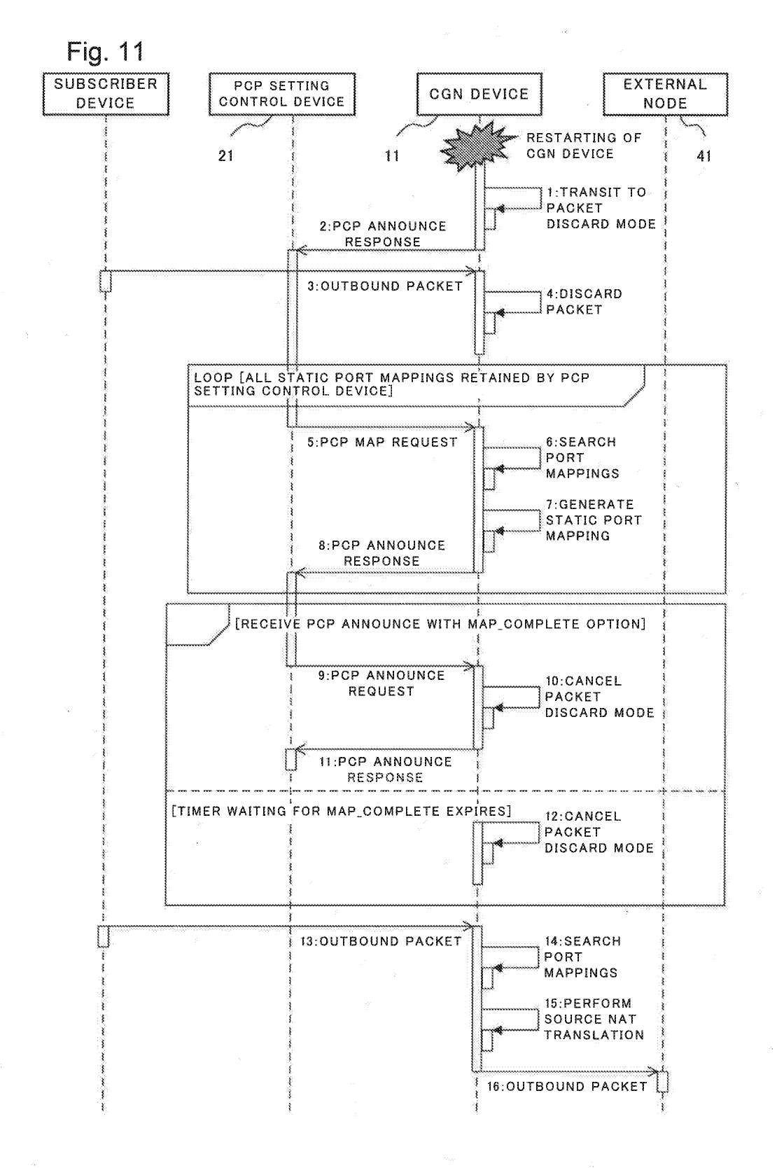

With reference to FIG. 11, in order to be recognized to the CGN device 11 the completion of re-setting of PCP MAP from the PCP setting control device 21, the PCP setting control device 21 may add a new message for notifying the CGN device 11 of the completion of the re-setting (Step 9 in FIG. 11). After the restarting, the CGN device 11 discards the packet flows and does not perform a dynamic assignment of a set of a public IP address and a public port (Step 1, Step 3 and Step 4 in FIG. 11). On the other hand, the CGN device 11 implements setting of PCP MAP (Step 5 through Step 8 in FIG. 11). This enables the PCP MAP to have a successful re-setting. In addition, after receiving the completion of the setting (Step 9 in FIG. 11), the CGN device 11 starts to forward the packet flows (Step 10 and Step 13 through Step 16 in FIG. 11).

Even when the CGN device 11 has not received the message for notifying of the completion of re-setting of the PCP MAP, the CGN device 11 may start as usual to forward the packet flows at the time of a lapse of a certain time from the restarting (Step 12 in FIG. 11). This enables the CGN device 11 to provide normal NAT translation functions, even when the PCP setting control device 21 cannot notify of the completion of the re-setting because of any troubles thereof.

### First Example Embodiment

Next, a communication system according to the first example embodiment will be described with reference to the drawings. It is assumed that the present example embodiment includes a case where a subscriber device in a private network and an external node in an external network are connected by using the CGN device.

### [Configuration]

A configuration of the communication system of the present example embodiment will be described with reference to FIG. 3. As illustrated in FIG. 3, the communication system of the present example embodiment includes the following devices:

CGN device 11

PCP setting control device 21

external nodes 41, 42

subscriber devices 31 to 33

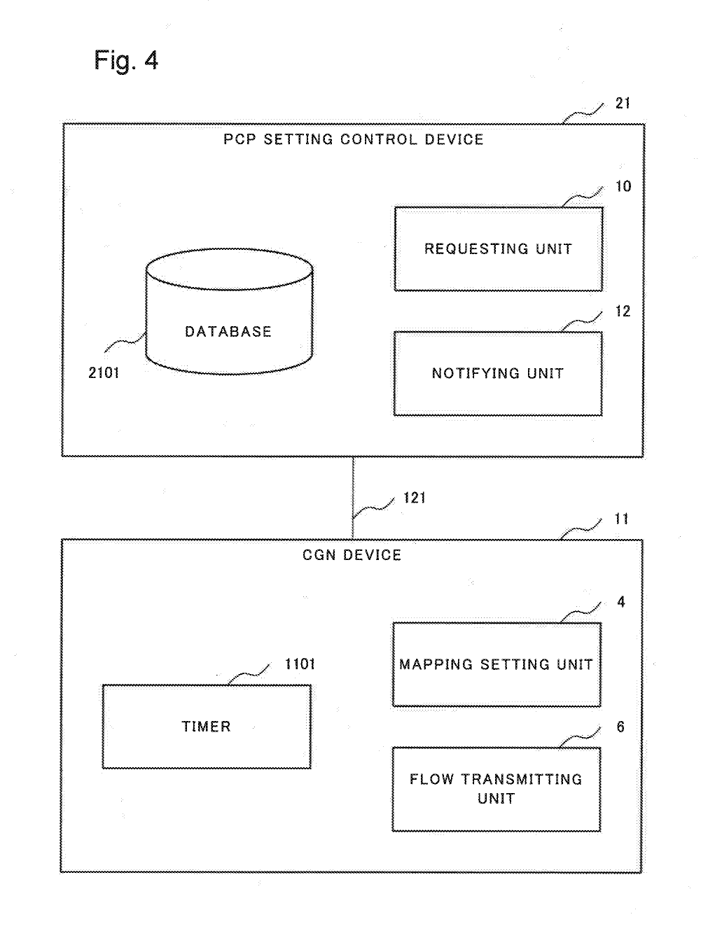

The CGN device 11 is a carrier grade NAT (CGNAT, CGS) device that can accommodate a plurality of users by expanding functions of a common NAT device. Requirements for the CGS device are defined in RFC6888 (NPL 2). FIG. 4 is a block diagram that exemplifies a more detailed configuration of the CGN device 11 and the PCP setting control device 21. With reference to FIG. 4, the CGN device 11 includes a timer 1101, a mapping setting unit 4, and a flow transmitting unit 6.

The timer 1101 includes a timer function. The mapping setting unit 4 sets a port mapping dynamically or statically as well as retains port mapping information that has been set dynamically or statically. The CGN device 11 includes, as internal state, “packet discard state”. When the internal state is in on-state, the flow transmitting unit 6 discards all the packets received from links 131 to 133, 140 in FIG. 3. On the other hand, when the internal state is in off-state, the flow transmitting unit 6 performs normal processing for the packet flows.

The PCP setting control device 21 is a device that acts as a reception for requests of setting of port mappings from the subscriber devices 31 to 33. With reference to FIG. 4, the PCP setting control device 21 includes a database 2101, a requesting unit 10, and a notifying unit 12.

The requesting unit 10 implements setting of a port mapping to the CGN device 11 in accordance with instructions of the subscriber devices 31 to 33. The database 2101 stores static port mapping information instructed from the subscriber devices 31 to 33. When the CGN device 11 is restarted, the notifying unit 12 notifies the CGN device 11 of the completion of re-setting of the static port mapping for the CGN device 11 upon the completion of the re-setting.

The external nodes 41, 42 are nodes that are on an external network, such as the Internet.

The subscriber devices 31 to 33 are devices that can perform Internet protocol (IP) communication, such as a personal computer (PC) or a smartphone.

Next, configurations of connections between the devices will be described.

The subscriber devices 31 to 33 connect with the CGN device 11 through the links 131 to 133, respectively.

As linking of the links 131 to 133, several systems have been known, such as a link in which dual-stack lite (DS-Lite) tunnels (RFC6333, NPL3) are used, a method for restricting IP addresses available corresponding to the subscriber devices 31 to 33. In any system, by inspecting packets received from the subscriber devices 31 to 33 according to the system of linking, the CGN device 11 can identify which of subscriber devices has transmitted the packets. In addition, assuming that the CGN device 11 recognizes how to transmit a packet toward a certain subscriber device, based on the subscriber's identification, in accordance with the method for identifying subscribes. Note that in the present example embodiment, methods of formation of the links are particularly not specified.

The subscriber devices 31 to 33 include connecting means with the PCP setting control device 21. In the present example embodiment, the connecting means are not specified. One example includes means for passing through links (or network) 231 to 233 specially designed for connecting.

The CGN device 11 connects with the external nodes 41, 42 through links 140 to 142. For example, as the links 140 to 142, common IP networks can be used.

The PCP setting control device 21 connects with the CGN device 11 through a link 121. The PCP setting control device 21 sets, to the CGN device 11, port mapping information instructed from the subscriber devices 31 to 33 by using PCP protocol. The PCP protocol is normalized in RFC6887 (NPL1). In the present example embodiment, a PCP protocol in which RFC6887 is expanded will be used.

Next, terms used in explanations of the present example embodiment will be defined.

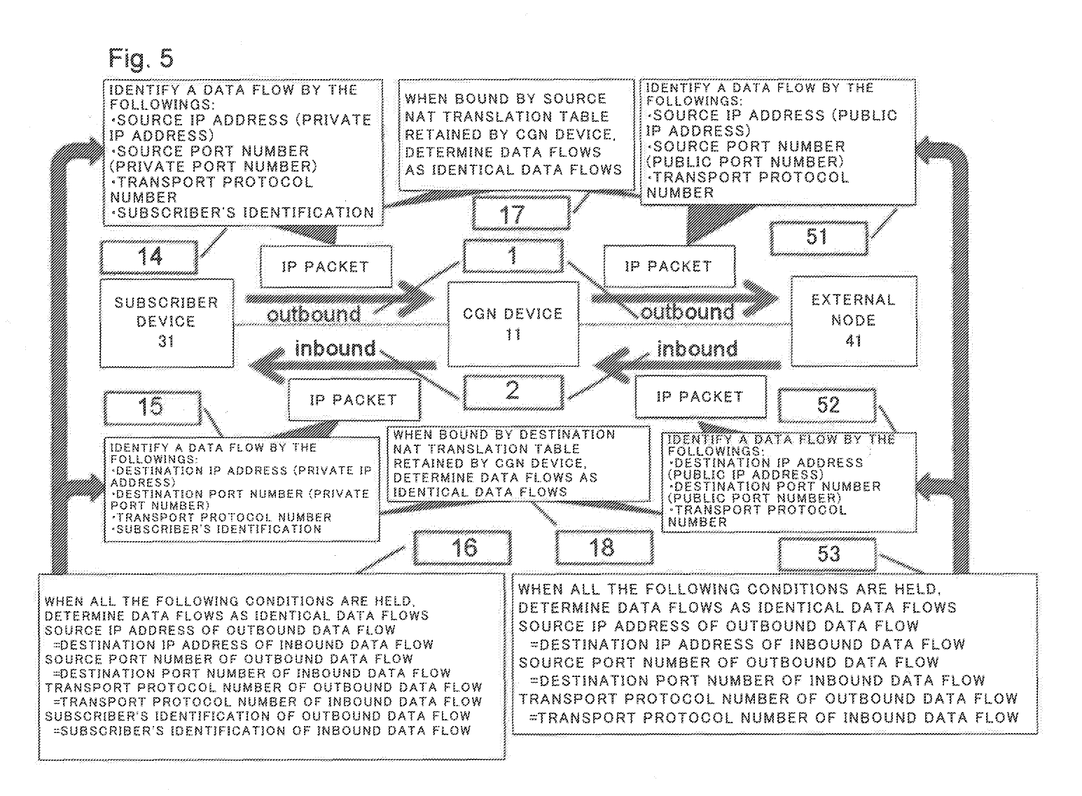

With reference to FIG. 5, terms concerning to a data flow, a definition of a data flow, and a method for determining whether or not data flows are identical are first defined. Note that although the subscriber device 31 and the external node 41 are illustrated as one example in FIG. 5, a similar explanation also may be applied to other subscriber devices and external nodes.

The term outbound refers to a direction from the subscriber device 31 toward the external node 41 (1 in FIG. 5). On the other hand, the term inbound refers to a direction from the external node 41 toward the subscriber device 31 (2 in FIG. 5).

The term data flow refers to a series of packet flows to be determined by the CGN device 11. There are a plurality of methods for defining a data flow. In the present example embodiment, for the sake of ease, the data flows are distinguished by a method in which IP addresses and port numbers of an external node 41 side are not distinguished.

For outbound packets between the CGN device 11 and external node 41, the CGN device 11 distinguishes the data flows by the following triad (11 in FIG. 5):

source IP address

source port number

transport protocol

For inbound packets between the CGN device 11 and external node 41, the CGN device 11 distinguishes the data flows by the following triad (12 in FIG. 5):

destination IP address

destination port number

transport protocol

In addition, when a set of (a source IP address, a source port number, a transport protocol) of an outbound packet and (a destination IP address, a destination port number, a transport protocol) of an inbound packet between the CGN device 11 and the external node 41 is identical, the CGN device 11 regards a lump of the series of the outbound packet and the series of the inbound packet as a single data flow (13 in FIG. 5).

On the other hand, for outbound packets and inbound packets between the subscriber device 31 and the CGN device 11, the CGN device 11 distinguishes the data flows by tetrad that includes the following in addition to the packet conditions for between the CGN device 11 and the external node 41 (14, 15 in FIG. 5):

subscriber's identification

In addition, when a set of (a source IP address, a source port number, a transport protocol, a subscriber's identification) of an outbound packet and (a destination IP address, a destination port number, a transport protocol, a subscriber's identification) of an inbound packet between the subscriber device 31 and the CGN device 11 is identical, the CGN device 11 regards a lump of the series of the outbound packet and the series of the inbound packet as a single data flow (16 in FIG. 5).

In addition, a data flow between the subscriber device 31 and the CGN device 11 and a data flow between the CGN device 11 and the external node 41 are bound by a port mapping managed by the CGN device 11, the CGN device 11 regards a lump of these series of the packets as a single data flow (17, 18 in FIG. 5).

Next, terms other than the term concerning to a data flow will be defined.

The term private IP address refers to an IP address of the subscriber device 31. The private IP address is guaranteed unique only within a certain subscriber network. Thus, between different subscribers, overlapping values may be used as their private IP addresses.

The term private port number refers to a port number assigned by the subscriber device 31 within the subscriber device 31 itself.

The term public IP address refers to an IP address pooled for the NAT translation in the CGN device 11. In general, a single CGN device 11 includes a plurality of public IP addresses.

The term public port number refers to a port number that is managed by binding to the public IP address by the CGN device 11. The CGN device 11 assigns a set of the public IP address and the public port number to a data flow correspondence between the subscriber device 31 and the CGN device 11. In the method for defining a data flow that is employed in the present example embodiment, a single public port number corresponds to a single dataflow.

The term port mapping refers to data that are retained by the CGN device 11, and the port mapping is used for performing the NAT translation. In the NAT translation, the CGN device 11 binds a data flow between the subscriber device 31 and the CGN device 11 and a data flow between the CGN device 11 and the external node 41. In the present example embodiment, the port mapping includes the following information:

subscriber's identification

private IP address

private port number

transport protocol

public IP address

public port number

When the CGN device 11 retains a certain port mapping, a data flow between the subscriber device 31 and the CGN device 11 is identified by a set of (a private IP address, a private port number, a transport protocol, a subscriber's identification). On the other hand, a data flow between the CGN device 11 and the external node 41 is identified by a set of (a public IP address, a public port number, a transport protocol). These data flows, or the dataflow between the subscriber device 31 and the CGN device 11 and the data flow between the CGN device 11 and the external node 41, are identified as a single data flow. The port mapping is classified into a dynamic port mapping or a static port mapping according to the generating method thereof.

The term dynamic port mapping refers to a port mapping that is dynamically generated on the CGN device 11, which is triggered by an outbound packet transmitted by the subscriber device 31. When the CGN device 11 is restarted, and when the CGN device 11 determines that the packets of the corresponding data flow have not flowed, the dynamic port mapping is automatically deleted.

On the other hand, the term static port mapping refers to a port mapping that is set on the CGN device 11 by transmitting a PCP MAP requesting message for the CGN device 11 by the PCP setting control device 21. The static port mapping is set and deleted by an explicit instruction by the PCP setting control device 21. In addition, when the CGN device 11 is restarted, the static port mapping is automatically deleted.

### [Operation]

Next, operations of each node will be described.

The mapping setting unit 4 in the CGN device 11 retains a plurality of port mappings as data. The flow transmitting unit 6 in the CGN device 11 receives a packet sent from the subscriber device 31 or the external node 41, performs the NAT translation to the packet with reference to the retained port mapping information, and forwards the packet.

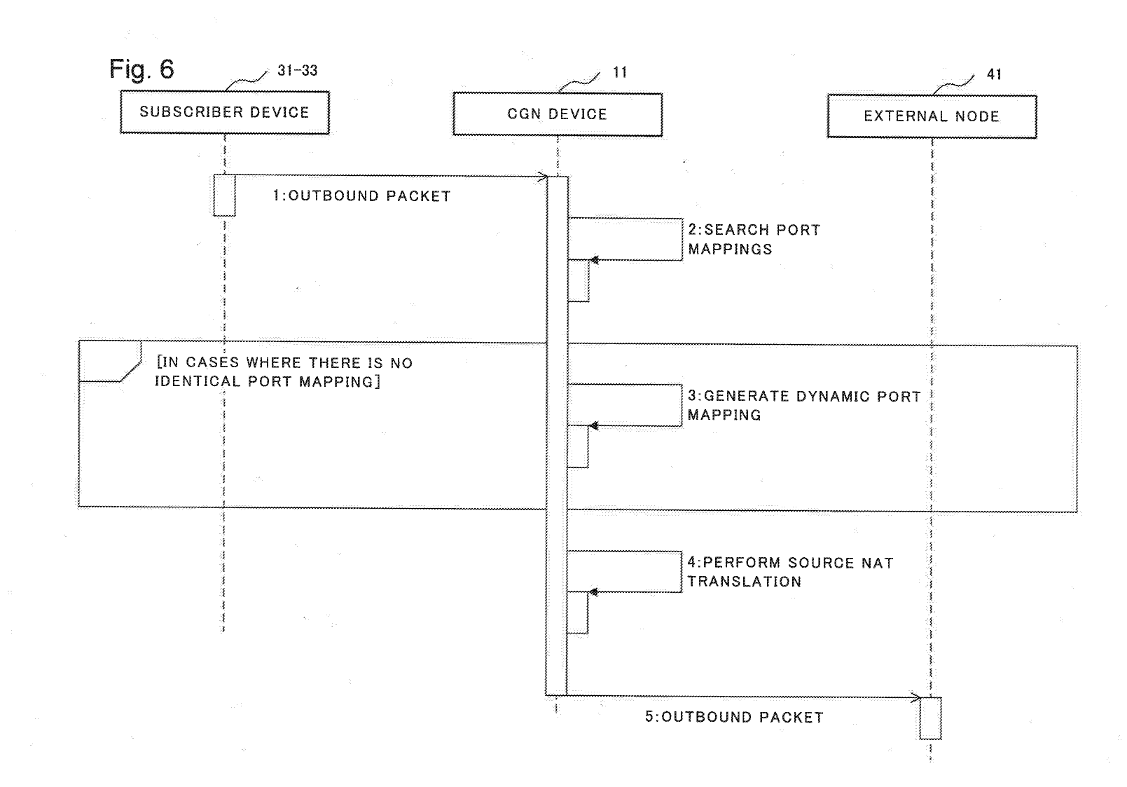

Operations of processing for an outbound packet will be described with reference to FIG. 6. Note that, for explanations of the links, FIG. 3 will be used for reference as appropriate. The processing for an outbound packet also acts as a trigger for generation of dynamic port mappings. On the subscriber devices 31 to 33, a plurality of applications are operated, and each of which independently performs communication with the external nodes 41, 42. Each of applications performs communication with the external nodes 41, 42 by using a defined transport protocol and by using a different private port number.

The CGN device 11 receives outbound packets sent by the subscriber devices 31 to 33 via the link 131 in FIG. 3 (Step 1 in FIG. 6).

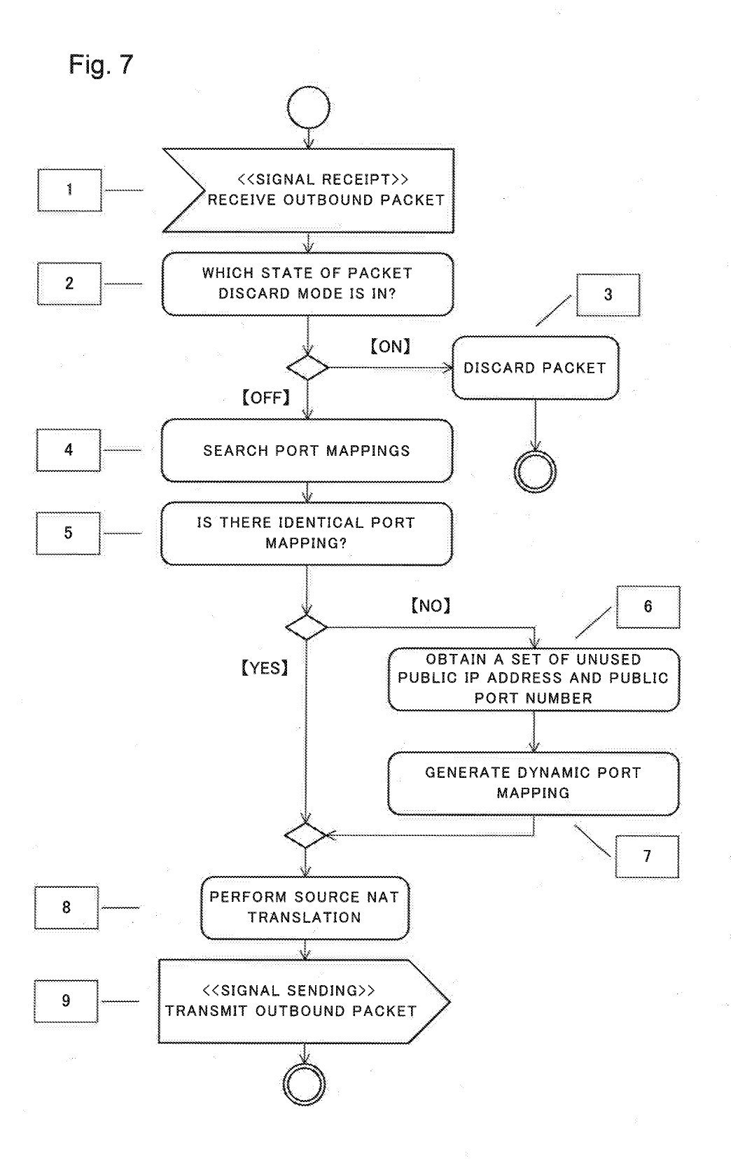

The CGN device 11 subjects the outbound packets to various processes described later with reference to FIG. 7 (Steps 2 through 4 in FIG. 6), and then transmits the outbound packets toward the external node 41 via the links 140, 141 in FIG. 3 (Step 5 in FIG. 6)

Detailed operations for processing the outbound packet by the CGN device 11 will be described with reference to FIG. 7. Upon received the outbound packet (Step 1 in FIG. 7), the CGN device 11 first inspects a packet discard mode itself (Step 2 in FIG. 7).

When the packet discard mode is in on-state, the flow transmitting unit 6 in the CGN device 11 discards the received packet (Step 3 in FIG. 7), and terminates the processing.

On the other hand, when the packet discard mode is in off-state, the flow transmitting unit 6 in the CGN device 11 retrieves a source IP address, a source port number, a transport protocol number, and a subscriber's identification from the packet. By using them as search keys, the flow transmitting unit 6 in the CGN device 11 searches port mappings retained by the mapping setting unit 4 in the CGN device 11 (Step 4 in FIG. 7).

Depending on a result of the search, the processing will be branched (Step 5 in FIG. 7). When there is no identical port mapping, the mapping setting unit 4 in the CGN device 11 first performs an assignment of a set of an unused public IP address and public port number in order to newly generate a dynamic port mapping (Step 6 in FIG. 7). Next, the mapping setting unit 4 in the CGN device 11 generates a new dynamic port mapping by combining the set with the values that have been retrieved from the received packet (Step 7 in FIG. 7).

By using the port mapping newly generated in Step 7 or the port mapping hit when searched in Step 4, the flow transmitting unit 6 in the CGN device 11 performs a source NAT translation to the received packet (Step 8 in FIG. 7). In addition, the flow transmitting unit 6 in the CGN device 11 transmits the packet toward the external node (Step 9 in FIG. 7).

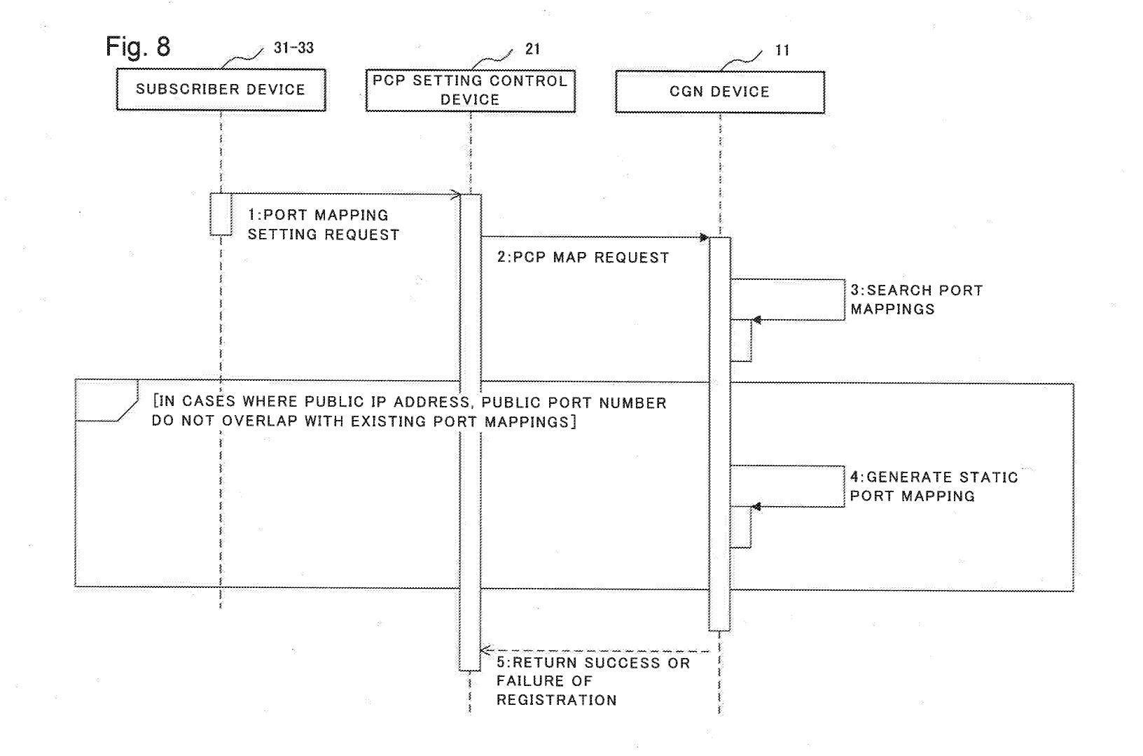

Next, the setting processing for the static port mapping will be described with reference to FIG. 8. Note that, for explanations of the links, FIG. 3 will be used for reference as appropriate. The subscriber devices 31 to 33 instruct, to the PCP setting control device 21, a request for setting of a port mapping via the link 231 in FIG. 3 (Step 1 in FIG. 8).

The requesting unit 10 in the PCP setting control device 21 translates contents of the request into a PCP MAP requesting message and transmits the message to the CGN device 11 by using the link 121 in FIG. 3 (Step 2 in FIG. 8).

The mapping setting unit 4 in the CGN device 11 inspects that the port mapping requested by the PCP MAP does not overlap with the port mappings already retained by the CGN device 11 (Step 3 in FIG. 8). “Two port mappings are overlapped” means that a set of (a subscriber's identification, a private IP address, a private port number, a transport protocol) among elements in one port mapping of the two port mappings is identical to those of the other port mapping or that a set of (a transport protocol, a public IP address, a public port number) of the one port mapping is identical to those of the other port mapping.

When the port mapping requested by the PCP MAP does not overlap with any of port mappings retained by the CGN device 11, the mapping setting unit 4 in the CGN device 11 sets the data thereof within the CGN device 11 as a static port mapping (Step 4 in FIG. 8). On the other hand, when there is an overlapping port mapping, the mapping setting unit 4 in the CGN device 11 does not retain such data.

In addition, the mapping setting unit 4 in the CGN device 11 returns success or failure of registration as the PCP MAP response message (Step 5 in FIG. 8).

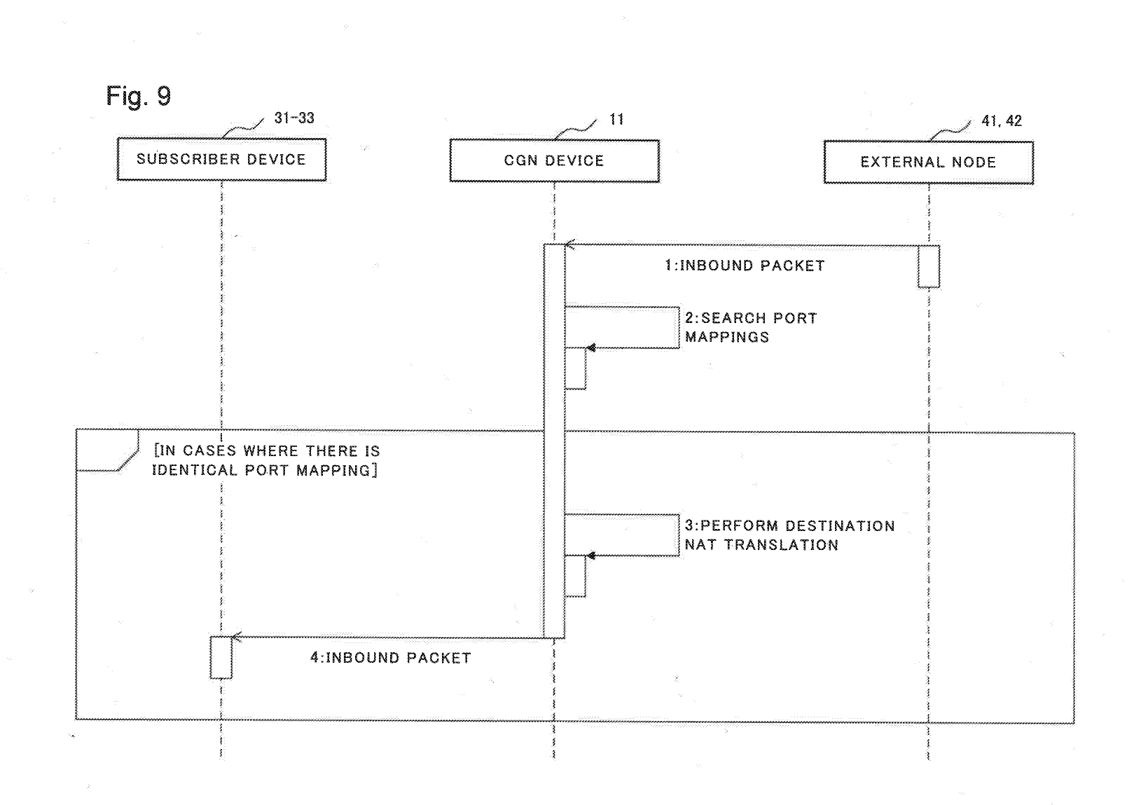

Next, operations of processing for an inbound packet will be described with reference to FIG. 9. Note that, for explanations of the links, FIG. 3 will be used for reference as appropriate. The external nodes 41, 42 transmit inbound packets to the CGN device 11 via the links 140 to 142 in FIG. 3 so that the external nodes 41, 42 response for communication that is received from the subscriber devices 31 to 33 or access servers on the subscriber devices 31 to 33 (Step 1 in FIG. 9).

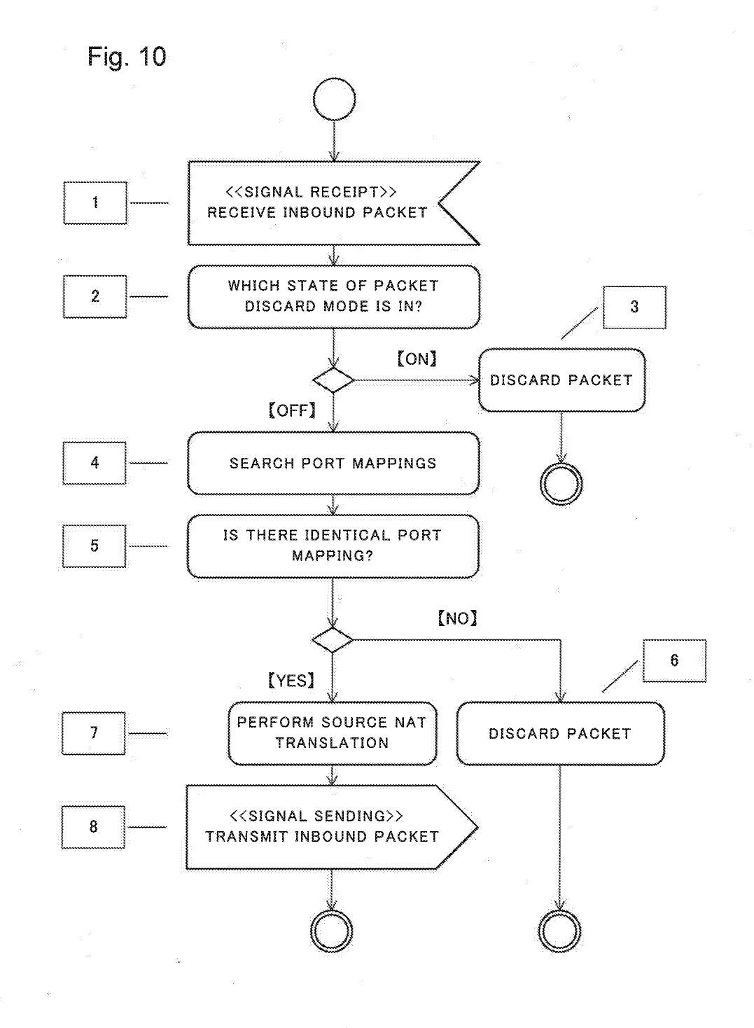

After implementing various processes (Steps 2, 3 in FIG. 9) described later with reference to FIG. 10, the flow transmitting unit 6 in the CGN device 11 that has received the inbound packets transmits the inbound packets toward the subscriber devices 31, 32 via the link 131 in FIG. 3 (Step 4 in FIG. 9).

Detailed operations for processing the inbound packet by the CGN device 11 will be described with reference to FIG. 10. Upon receiving the inbound packet (Step 1 in FIG. 10), the flow transmitting unit 6 in the CGN device 11 first inspects the packet discard mode itself (Step 2 in FIG. 10).

When the packet discard mode is in on-state, the flow transmitting unit 6 in the CGN device 11 discards the received packet (Step 3 in FIG. 10), and terminates the processing.

On the other hand, when the packet discard mode is in off-state, the flow transmitting unit 6 in the CGN device 11 retrieves a destination IP address, a destination port number, and a transport protocol number from the packet. By using them as search keys, the flow transmitting unit 6 in the CGN device 11 searches port mappings retained by the mapping setting unit 4 in the CGN device 11 (Step 4 in FIG. 10).

Depending on a result of the search, the processing will be branched (Step 5 in FIG. 10). When there is no identical port mapping, the flow transmitting unit 6 in the CGN device 11 discards the received inbound packet (Step 6 in FIG. 10), and terminates the processing.

On the other hand, when there is an identical port mapping, the flow transmitting unit 6 in the CGN device 11 performs the destination NAT translation to the received packet by using the port mapping that has been hit (Step 7 in FIG. 10). In addition, the flow transmitting unit 6 in the CGN device 11 transmits the packet toward the subscriber device 31 (Step 8 in FIG. 10).

Next, the processing in cases where the CGN device 11 is restarted will be described with reference to FIG. 11. Note that, for explanations of the links, FIG. 3 will be used for reference as appropriate.

When the CGN device 11 is restarted, the CGN device 11 starts the processing with on-state of the packet discard state (Step 1 in FIG. 11). At this time, the CGN device 11 activates the timer 1101 waiting for MAP_COMPLETE. Further, the mapping setting unit 4 in the CGN device 11 clears away all the port mapping information.

The mapping setting unit 4 in the CGN device 11 transmits a PCP ANNOUNCE response message to the PCP setting control device 21 via the link 121 in FIG. 3 (Step 2 in FIG. 11).

At this time, there is a possibility that a subscriber device (e.g., subscriber device 31) that does not recognize restarting of the CGN device 11 transmits the outbound packet toward the CGN device 11 via a link (e.g., link 131) in FIG. 3 (Step 3 in FIG. 11).

The flow transmitting unit 6 in the CGN device 11 with this state that has received the outbound packet discards the received packet due to the on-state of the packet discard state thereof (Step 4 in FIG. 11).

When receiving the PCP ANNOUNCE response message and determining that the CGN device 11 is restarted, the requesting unit 10 in the PCP setting control device 21 reads static port mapping information from the information retained by the PCP setting control device 21 and transmits a PCP MAP request message to the CGN device 11, thus setting all of which (Step 5 in FIG. 11).

The mapping setting unit 4 in the CGN device 11 that has received the PCP MAP request message performs processing similar to the processing for the static port mapping information in FIG. 8, and sets, for itself, only the port mapping information that is not overlapping (Steps 6, 7 in FIG. 11).

The mapping setting unit 4 in the CGN device 11 then transmits a result of the processing as the PCP MAP response message toward the PCP setting control device 21 (Step 8 in FIG. 11).

The notifying unit 12 in the PCP setting control device 21 that has completed setting of all the static port mappings transmits, to the CGN device 11, a PCP ANNOUNCE request message in which a MAP_COMPLETE option newly defined in the present example embodiment is set (Step 9 in FIG. 11).

Upon receiving the PCP message with the MAP_COMPLETE option, the mapping setting unit 4 in the CGN device 11 cancels the packet discard mode (Step 10 in FIG. 11) and sends back the PCP response message (Step 11 in FIG. 11).

Alternatively, even when the CGN device 11 has not received the PCP message with the MAP_COMPLETE option, the CGN device 11 cancels the packet discard mode upon expiration of the timer waiting for MAP_COMPLETE (a lapse of a predetermined time period) (Step 12 in FIG. 11).

Due to cancellation of the packet discard mode, when the outbound packet sent from the subscriber device 31 is received by the CGN device 11 (Step 13 in FIG. 11), processing similar to the processing for the normal outbound packet of FIG. 7 is performed. Namely, the flow transmitting unit 6 in the CGN device 11 implements port mapping search (Step 14 in FIG. 11) and the source NAT translation (Step 15 in FIG. 11) and transmits the packet to the external node 41 (Step 16 in FIG. 11).

### [Effect]

The communication system of the present example embodiment provides the following effects.

As a first effect, when the CGN device is restarted, the generation of a dynamic port mapping by the outbound packet and the setting of a static port mapping from the PCP setting control device do not compete. This can ensure that the static port mapping that has been available prior to the restarting of the CGN device is available also after restarting of the CGN device.

As a second effect, employing the timer waiting for MAP_COMPLETE allows the CGN device to resume to forward data flows after a lapse of a certain time, even when the PCP message missing during communication channels on the way occurs, and/or even when the PCP setting control device that does not support the MAP_COMPLETE and the CGN device that is equivalent to the operations of the present example embodiment are combined.

As a third effect, employing the MAP_COMPLETE option allows the CGN device to resume to forward data flows upon completion of re-setting of the PCP MAP by the PCP setting control device. Therefore, when the CGN device is restarted, a time period in which the CGN device is suspending the forwarding of the data flows can be shortened.

### Second Example Embodiment

Next, a second example embodiment of the present invention will be described with reference to the drawings. In the first example embodiment, the subscriber devices 31 to 33 set a port mapping to the CGN device 11 with passing through the PCP setting control device 21. On the other hand, in present example embodiment, the subscriber devices 31 to 33 transmit a PCP MAP request message directly to the CGN device 11 without passing through the PCP setting control device 21.

### [Configuration]

FIG. 12 is a diagram that exemplifies a network configuration of a communication system according to the present example embodiment. With reference to FIG. 12, the communication system of the present example embodiment has a configuration in which the PCP setting control device 21 is removed from the communication system of the first example embodiment illustrated in FIG. 3. Further, in the present example embodiment, subscriber devices 31 to 33 includes the database (or nonvolatile memory) 2101 for static port mappings (FIG. 3) (databases 3101, 3201, 3301 in FIG. 12), which is provided in the PCP setting control device 21 in the first example embodiment.

The subscriber devices 31 to 33 transmit PCP MAP request messages for port mapping requests directly onto, respectively, links 131 to 133 connected to the CGN device 11. In addition, through these links 131 to 133, the CGN device 11 sends back PCP MAP response messages. Similarly, PCP ANNOUNCE messages are also transmitted/received by using these links 131 to 133.

### [Operation]

In the present example embodiment, for example, there are two cases for operations below depending on a PCP's version supported by the subscriber devices 31 to 33, and depending on whether or not the CGN device 11 has information concerning to support circumstances with the PCP's version of the subscriber devices 31-33.

As a first case, there is a case that it can be ensured that all the subscriber devices 31 to 33 support the MAP_COMPLETE option, and the CGN device 11 can grasp information about all the subscriber devices 31 to 33. In this case, like the first example embodiment, when restarted, the CGN device 11 blocks forwarding of data flows until at the earlier time point of either receipt of MAP_COMPLETEs from all the subscriber devices 31 to 33, or expiration of a timer waiting for the MAP_COMPLETE. After the time point, the CGN device 11 starts to forward the data flows.

On the other hand, as a second case, there is a case that at least one of subscriber devices that does not support the MAP_COMPLETE option. If there is such a possibility, when restarted, the CGN device 11 waits expiration of the timer waiting for MAP_COMPLETE and then starts to forward the data flows.

The communication system according to the second example embodiment enables the packets transmitted from external nodes 41, 42 to be delivered certainly to the subscriber devices 31 to 33, even when the CGN device 11 is restarted. The reason is that when the CGN device 11 is restarted, the packet flows from the subscriber devices 31 to 33 are discarded until receiving, from the subscriber devices 31 to 33, a notification that indicates completion of re-setting of a static port mapping for the CGN device 11 or until a lapse of a time period counted by the timer, and the CGN device 11 can complete the static port mapping prior to performing of a dynamic port mapping for the packet flows from the subscriber devices 31 to 33.

The first and second example embodiments can be modified in various ways, including the following modifications.

### <Modification 1>

The first example embodiment illustrates that it includes a single PCP setting control device. However, the invention according to the example embodiments above can be applied to also a case where there are a plurality of PCP setting control devices. In this case, the CGN device stores the IP addresses of the PCP setting control devices, also after restarting, as destination of a PCP ANNOUNCE response message. In addition, the CGN device ends the packet discard mode and starts normal forwarding of the packets at the earlier timing of either receipt of MAP_COMPLETE options from all the PCP setting control devices or expiration of a timer waiting for MAP_COMPLETE.

### <Modification 2>

The first and second example embodiments illustrate a case of NAPT translation. However, the invention according to the example embodiments above can be applied to also a case where NAT translation in the narrow sense that performs only translation of IP addresses, but does not perform translation of port numbers.

### <Modification 3>

The first and second example embodiments illustrate a method for putting the MAP_COMPLETE option onto the PCP ANNOUNCE request message. However, a method for additionally putting the MAP_COMPLETE option onto a PCP MAP request message according to the relevant art can be used. In this case, an example of the PCP setting control device includes a method for putting a MAP_COMPLETE option onto a PCP MAP request message that instructs a setting for last one of static mappings to be re-set.

### <Modification 4>

The first and second example embodiments illustrate a case of the CGN device. However, the invention according to the example embodiments above can be applied to also a case where a normal NAT device, such as broadband routers, are used.

### <Modification 5>

The first and second example embodiments illustrate a method for adding the MAP_COMPLETE option on the basis of the standard protocol that is defined in RFC6887 (NPL1) as the PCP protocol. However, a method for adding a MAP_COMPLETE option on the basis of a PCP protocol that is subjected to expansion of functions as defined in other RFCs or Internet-drafts can be employed.

### <Modification 6>

The first and second example embodiment illustrate, for simplifying explanations thereof, a method for identifying outbound data flows by the tetrad, a subscriber's identification, a private IP address, a private port number, a transport protocol. This method is a method for realizing the Endpoint-Independent Mapping behavior defined by RFC4787 (NPL4). A method for identifying inbound data flows by the triad, a public IP address, a public port number, a transport protocol is also illustrated. This method is a method for realizing the Endpoint-Independent Filtering behavior defined by RFC4787. However, as mapping behaviors, methods such as an Address-Dependent Mapping and an Address and Port-Dependent Mapping other than the Endpoint-Independent Mapping also have been known. As filtering behaviors, methods such as an Address-Dependent Filtering and an Address and Port-Dependent Filtering other than the Endpoint-Independent Filtering also have been known. The invention according to the example embodiments above can be applied to also any of these mapping behaviors and filtering behaviors without any modifications in particular.

Note that, as different solutions from the solutions illustrated in the example embodiments and modifications above, there is also a method for retaining the port mapping information in a nonvolatile memory by the CGN device and, after restarting of the CGN device, restoring the retained port mapping information. However, such a method causes the following problems (1), (2).

(1) As a cause of restarting of the CGN device, there is also a case in which the CGN device has been in an abnormal state before activation thereof. In such a case, it is not guaranteed that port mapping information after the restarting is correct. Thus, the problem is that it is required to provide another structures that guarantees synchronization for nonvolatile regions, resulting in complicating controls and configuration of the device.

(2) Furthermore, the problem is that it is required to prepare, for the CGN device, the nonvolatile regions in proportion to numbers of mapping, resulting in making a device expensive.

Since employing the methods according to the example embodiments or modifications above allows controls to be simplified, the problem as (1) above is not caused. Further, since the example embodiments or modifications above do not require addition of the nonvolatile regions, the problem of (2) above is also not caused.

In addition, since the expansion of the MAP_COMPLETE option in the example embodiments above utilizes the detection mechanism of re-setting in the PCP protocol, it is only required that a static message is sent at the end of the re-setting processing. Therefore, the invention according to the example embodiments above can be applied to an existing CGN device and PCP setting control device without great modifications thereof.

The invention according to the example embodiments above can be applied to, as one example, the field of communications that utilizes an NAT device performing CGNAT.

In the present invention, the following modes are further available.

### [Mode 1]

A network address translation device according to the network address translation device according to the first aspect.

### [Mode 2]

The network address translation device according to the Mode 1, wherein the flow transmitting unit discards the packet flow until a lapse of a predetermined time period after the restarting.

### [Mode 3]

The network address translation device according to the Mode 1 or 2,

wherein the mapping setting unit sets a static port mapping in response to a request from a setting requesting device that requests setting of the static port mapping by using a port control protocol (PCP).

### [Mode 4]

The network address translation device according to the Mode 1 or 2,

wherein the flow transmitting unit starts to transmit the packet flow upon receipt of the notification or a lapse of the predetermined time period.

### [Mode 5]

The network address translation device according to any one of the Modes 1 to 4,

wherein the mapping setting unit performs re-setting of the static port mapping before receiving the notification or the lapse of the predetermined time period.

### [Mode 6]

The network address translation device according to any one of the Modes 1 to 5,

wherein the mapping setting unit suspends setting of a dynamic port mapping for a packet flow received from the subscriber device before receiving the notification or the lapse of the predetermined time period.

### [Mode 7]

The network address translation device according to any one of the Modes 1 to 6,

wherein the setting requesting device requests setting of a port mapping to the network address translation device in accordance with instructions from the subscriber device.

### [Mode 8]

The network address translation device according to any one of the Modes 1 to 6,

wherein the setting requesting device and the subscriber device is the same device.

### [Mode 9]

The network address translation device according to any one of the Modes 1 to 8,

wherein the network address translation device is a carrier grade network address translation (CGN) device.

### [Mode 10]

A setting requesting device according to the setting requesting device according to the second aspect.

### [Mode 11]

The setting requesting device according to the Mode 10,

wherein the requesting unit requests setting of a static port mapping by using a port control protocol (PCP) for the network address translation device.

### [Mode 12]

The setting requesting device according to the Mode 10 or 11,

wherein the requesting unit requests setting of the static port mapping to the network address translation device in accordance with instructions from the subscriber device.

### [Mode 13]

The setting requesting device according to the Mode 10 or 11,

wherein the setting requesting device is the subscriber device.

### [Mode 14]

A communication system according to the third aspect.

### [Mode 15]

A communication method according to the fourth aspect.

### [Mode 16]

A program according to the fifth aspect.

### [Mode 17]

A network address translation device, including: a mapping setting unit that sets a static port mapping in response to a request from a setting requesting device that requests setting of the static port mapping by using a port control protocol (PCP) as well as sets a dynamic port mapping upon receiving a packet flow from a subscriber device; and

a flow transmitting unit that subjects the packet flow from the subscriber device to address translation, based on the static port mapping and the dynamic port mapping that have been set by the mapping setting unit, and transmits the packet flow,

wherein when the network address translation device is restarted, the flow transmitting unit discards the packet flow until receiving, from the setting requesting device, a notification that indicates completion of re-setting of the static port mapping for the network address translation device.

Note that it is assumed that the entire disclosed contents of PTL1 and NPLs 1 to 4 above are incorporated and described herein by reference. Variations and adjustments of the example embodiments are possible within the scope of all the disclosure of the present invention (including the Claims), and further based on basic technical idea thereof. In addition, various combinations or selections of a variety of disclosed components (including each component in each claim, each component in each example embodiment, each component in each figure, and the like) are possible within the scope of all the disclosure of the present invention. Namely, it is needless to say that the present invention includes various modifications or revisions thereof that could be made by those skilled in the art in accordance with all the disclosure including the Claims or the technical idea thereof. Especially, for numeric ranges described herein, any numerical values or smaller ranges included within the numeric ranges should be interpreted as describing specifically, even if not otherwise specified.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2016-052563, filed on Mar. 16, 2016, the disclosure of which is incorporated herein in its entirety by reference.

### REFERENCE SIGNS LIST

2 network address translation device
4 mapping setting unit
6 flow transmitting unit
8 setting requesting device
10 requesting unit
11 CGN device
12 notifying unit
21 PCP setting control device
31-33 subscriber device
41, 42 external node
121, 131-133, 140-142 link
231-233 link (or network)
1101 timer
2101, 3101, 3201, 3301 database

What is claimed is:

1. A network address translation device comprising:
a mapping setter configured to set a static port mapping in response to a request from a setting requesting device that requests setting of the static port mapping; and
a flow transmitter configured to subject a packet flow from a subscriber device to address translation, based on the static port mapping that has been set by the mapping setter, and transmit the packet flow,
wherein when the network address translation device is restarted, the flow transmitter discards the packet flow until receiving, from the setting requesting device, a notification that indicates completion of re-setting of the static port mapping for the network address translation device.

2. The network address translation device according to claim 1,
wherein the mapping setter sets a static port mapping in response to a request from a setting requesting device that requests setting of the static port mapping by using a port control protocol (PCP).

3. The network address translation device according to claim 1,
wherein the flow transmitter discards the packet flow until a lapse of a predetermined time period after restarting.

4. The network address translation device according to claim 3,
wherein the flow transmitter starts to transmit the packet flow upon receipt of the notification or a lapse of the predetermined time period.

5. The network address translation device according to claim 3,
wherein the mapping setter performs re-setting of the static port mapping before receiving the notification or the lapse of the predetermined time period.

6. The network address translation device according to claim 3,
wherein the mapping setter suspends setting of a dynamic port mapping for a packet flow received from the subscriber device before receiving the notification or the lapse of the predetermined time period.

7. A setting requesting device comprising:
a requester configured to request setting of a static port mapping for a network address translation device that subjects a packet flow from a subscriber device to address translation, based on the static port mapping that has been set, and transmits the packet flow; and
a notificator configured to, when the network address translation device is restarted, notify the network address translation device of completion of re-setting of the static port mapping for the network address translation device upon the completion of the re-setting.

8. (canceled)

9. A communication method comprising:
restarting a network address translation device that sets a static port mapping in response to a request from a setting requesting device that requests setting of the static port mapping, subjects a packet flow from a subscriber device to address translation, based on the static port mapping that has been set, and transmits the packet flow;
receiving, by the network address translation device, a notification that indicates completion of re-setting of the static port mapping for the network address translation device from the setting requesting device, after the restarting; and
discarding, by the network address translation device, the packet flow until receiving the notification.

10. (canceled)
